(19) United States
(12) Patent Application Publication
(10) Pub. No.: US 2004/0015996 A1
(43) Pub. Date: Jan. 22, 2004

(54) Digital data reception box with modem-type interfaces

(76) Inventor: Arnaud Chataignier, Leves (FR)

Correspondence Address: GREENBLUM & BERNSTEIN, P.L.C., 1950 ROLAND CLARKE PLACE, RESTON, VA, 20191, US

(21) Appl. No.: 10/297,912

(22) PCT Filed: Jun. 26, 2001
(86) PCT No.: PCT/FR01/02014

(30) Foreign Application Priority Data
Jun. 26, 2000 (FR) 00/08139

(51) Int. Cl. H04N 7/173

(52) U.S. Cl. 725/106; 725/110; 725/131; 725/111

(57) ABSTRACT

Digital data reception box allowing users to receive digital data coming from a data transmission network. The reception box includes a connection box, a first modem-type interface, a second modem-type interface and a reception interface that is different from the first and second modem-type interfaces. The first modem-type interface is used to access a display box for receiving data coming from the reception interface. The second modem-type interface is used to render, in a transparent manner, the use of the first modem-type interface.

The present invention relates to a digital data reception box having two modem-type interfaces.

In particular, its object is to allow the users to receive digital data originating from a transmission source (e.g., satellite reception). The data can be, for example, web sites downloaded from the Internet and formatted, the selected sites being “downloaded” on the Internet and formatted for satellite transmission before being transmitted to the end users.

The term “modem-type interface” is used in this application with reference to an interface using a telephone line to transmit data.

Geostationary satellites are capable of transmitting numerous programs that can be easily picked-up due to a small individual parabolic antenna. This antenna permanently points to the selected satellite, whose position in space, relative to the earth, does not change. This ease of reception of a wide variety of programs is currently significantly slowing down the development of cabled networks.

Moreover, the digital satellite transmission allows sending computer data to terminals (television sets or computers) at high speed.

The gap is closing between commercial Internet providers and television networks. The television monitor could be used as a terminal for the Internet, while the computer monitor would allow receiving television programs, pending a complete integration of the networks and the reception on a same monitor. With this perspective, the possibilities of satellite connection to the Internet are bound to increase substantially.

On receiving sites, the receivers can find one or several “chunks of data” in the flows transmitted by satellite, from which the data must be filtered and extracted in order to be presented to the user on a TV screen or computer monitor.

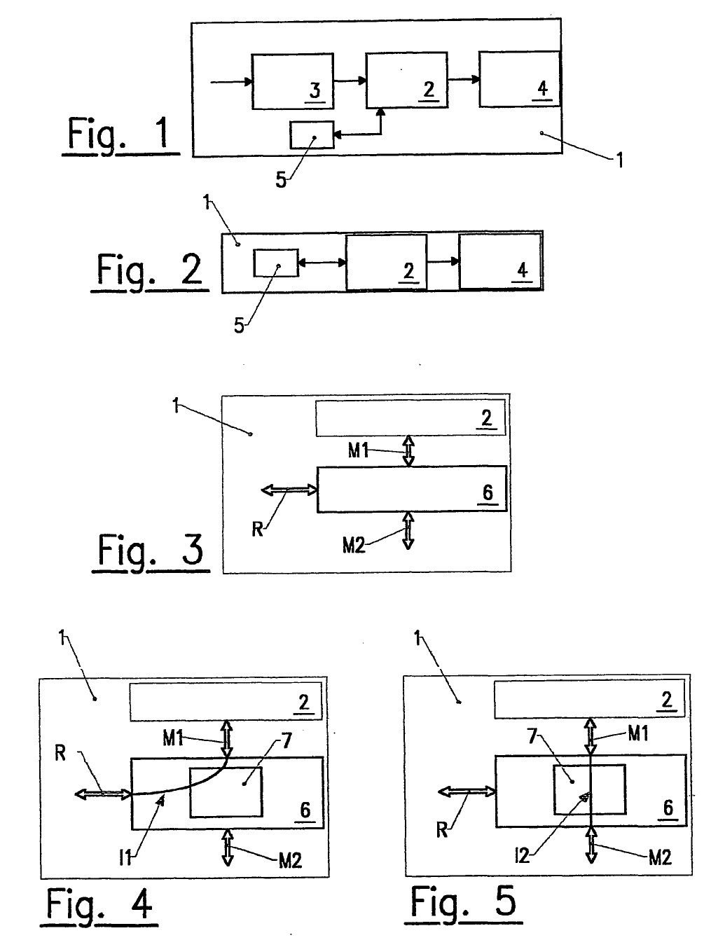

The manner of presenting the data received depends upon the display platform 1 used (FIGS. 1 and 2). This platform can be in the form of a personal computer provided with a monitor or a satellite reception card, or yet in the form of a box 2 connected to a television set.

Certain display boxes 2, of the “open” type, are equipped with one or several interfaces that make it possible to add peripherals to the system. This is the case, for example, of stand-alone computers.

The data satellite reception box 3 and the display box 2 (computer, decoder) attached to the screen 4 are connected to one another by a generally standardized interface designed to connect one or several peripherals. These “open” type display boxes can also be provided with an interface for a modem 5 (FIG. 1).

The “closed” type display boxes 2 are not provided to enable peripherals to be easily added. These can be, for example, Internet browsing terminals, game consoles. Access to the outside world (for example, the Web) is then generally obtained by a modem-type interface using a conventional telephone line (FIG. 2).

Currently, the receiving peripherals (satellite, cable, etc.) can only be used with the “open” type display boxes 2.

The object of the device according to the present invention is to make it possible to use the modem interface present on any display box to connect a receiving peripheral which may not have a link to the telephone network (for example, a satellite receiver), the data received being presented to the display box of the “open” or “closed” type by means of its modem interface.

It is constituted of a connection box comprising three interfaces, namely, two modem-type interfaces and a reception interface of a different type than a modem (for example, satellite reception).

In the attached drawings, provided by way of a non-limiting example of one of the embodiments of the object of the invention:

FIGS. 1 and 2, mentioned hereinabove, show reception platforms equipped with an “open” display box and a “closed” display box;

FIG. 3 shows the connection box with three interfaces; and

FIGS. 4 and 5 show the connection box connecting a display box to a modem and to a receiver of a different type, respectively.

The device, FIGS. 3-5, is constituted of a connection box 6 equipped with an optional buffer memory 7 and two modem-type interfaces M1, M2, as well as a reception interface R that is not a modem, the interface M1 being used to access a display box 2 for receiving data coming from the interface R, and the interface M2 being used to render the use of M1 transparent.

The display box 2 uses its modem interface when access to the outside is necessary. This interface is usually connected directly to a telephone line. The connection box 6 is inserted on this line.

The display box is connected to the interface M1 of the connecting box 6 that is further connected to the telephone line by its interface M2. A third interface R is present on the connection box and enables the reception or transmission of data. This interface can be a satellite reception interface, for example. The data received or transmitted on the interfaces M2 and R therefore use the transmission/reception channel constituted by the interface M1 (modem interface of the display box 2) (FIG. 3).

The reception interface R of the connection box 6 allows receiving (or transmitting), without connection to the telephone line, data coming from an information transmission network (satellite, cable or digital terrestrial, or other network). The display by means of the interface M1 occurs in several steps.

The display box 2 needs data. It then sends a request for connection to what it interprets as a telephone line, but which, in our case, is the interface M1.

The connection box intercents the call and simulates the telephone line. No call is yet carried out on the actual telephone line (interface 2).

A first internal connection 11 is established in the connection box 6. The display box requests the necessary data. The connection box intercepts the request and compares it with the data stored in the optional memory 7 and the data that is available on the interface R and not stored. In this case, the interface R must then either broadcast this information (satellite), or offer a mechanism for requesting this information (cable).

The comparison can be made due to the address of the desired data, for example.

The stored data comes either from the reception interface R where they were received previously, or from a previous connection to the interface M2.

If the requested data corresponds to data that is available without connection to the interface M2 (telephone line), it is returned to the display box 2 by means of the interface M1 (FIG. 4).

In the case where a connection to the actual telephone line (interface M2) is necessary, the reception box 6 then becomes transparent and connects the interfaces M1 and M2 by activating a second internal connection 12. The different steps necessary to achieve this result are as follows:

The display box 2 needs data. It then sends a request for connection to what it interprets as a telephone line, but which, in our case, is the interface M1.

The connection box 6 intercepts the call and simulates the telephone line. No call is carried out on the actual telephone line (interface M2). Since the connection is established, the display box requests the necessary data.

The connection box 6 intercepts the request and compares it with the data stored in the memory 7 and the data that is available by means of the reception interface R.

If the requested data does not correspond to data that is available without connection to the interface M2 (telenhone line) a connection to this interface is necessary.

A connection 12 to the interface M2 is made. The connection parameters used are the same as those used during the request for connection to the interface M1.

The request for data is sent to the interface M2.

The data received on the interface M2 is sent to the display box on the interface 1 (FIG. 5).

The modem interface can be a wireless interface such as GSM, DECT, WAP, Blue Tooth or other wireless protocol allowing the connection of a telephone or mobile peripheral for browsing and/or transmitting Internet data or other types of mail services.

The connection box 6 can advantageously be equipped with a telephone jack making it possible to accept the connection of a terminal of the Minitel type or any other terminal for access to the Internet that is connected via a telephone jack.

The positioning of the various components gives the object of the invention a maximum of useful effects that, until now, had not been obtained by similar devices.

1. Digital data reception box having two modem-type interfaces enabling the users to receive digital data coming from a data transmission network,
characterized in that it is constituted of a connection box (6) equipped with an optional buffer memory (7) and two modem-type interfaces (M1,M2), as well as a reception interface (R) of a different type, one of the modem-type interfaces (M1) being used to access a display box (2) for receiving data coming from the reception interface (R), and the second (M2) being used to render the use of the first (M1) transparent.

2. Reception box according to claim 1, characterized in that it is arranged so as to be capable of being inserted, due to the two modem-type interfaces (M1, M2), on a telephone line normally connected to a display box (2) connected to a receiver 4, such as a computer or television set.

3. Reception box according to claim 2, characterized in that it can be rendered “transparent” in the case of a connection to an actual telephone line, by activation of an internal connection (12).

4. Reception box according to any of the preceding claims, characterized in that the reception interface (R) is adapted to receive data coming from an information transmission network (satellite, cable or digital terrestrial, or other network).

5. Reception box according to claim 4, characterized in that the reception interface (R) is equipped with a mechanism for requesting this information.

6. Reception box according to any of the preceding claims, characterized in that the reception interface (R) enables the reception or transmission of data.

7. Reception box according to any of the preceding claims, characterized in that it is arranged to receive or transmit data without connection to a telephone line by intercepting the call coming from the display box (2), and by simulating the telephone line, then by activating an internal connection (11) between the interface (M1) connected to said display box and the reception interface (R).

8. Reception box according to any of the preceding claims, characterized in that it can be store in the optional memory (7) data coming either from the reception interface (R) where they were received previously, or from a previous connection to the interface (M2) connected to the telephone line.

9. Reception box according to any of claim 7 and 8, characterized in that it is arranged to compare a request coming from the display box (2), and normally directed to the telephone line, with the data stored in the memory (7) and the stored or not stored data available on the interface (R).

10. Reception box according to any of the preceding claims, characterized in that it is equipped with a telephone jack making it possible to accept the connection of a terminal of the Minitel type or any other terminal for access to the Internet that is connected via a telephone jack.

11. Reception box according to any of the preceding claims, characterized in that the modem interface is a “GSM” type wireless interface or any other wireless protocol enabling the connection of a telephone or a mobile peripheral for browsing and/or transmitting Internet data or other mail services.
